(19) United States
(12) Patent Application Publication
(10) Pub. No.: US 2019/0308103 A1
(43) Pub. Date: Oct. 10, 2019

(54) REAL-TIME VIRTUAL GOODS INVENTORY MECHANISM

(71) Applicant: Zynga Inc., San Francisco, CA (US)

(72) Inventor: Ouri Lahav, Austin, TX (US)

(21) Appl. No.: 15/947,445

(22) Filed: Apr. 6, 2018

(51) Int. Cl. A63F 13/60; G06Q 30/06; G06F 11/34

(52) U.S. Cl. CPC A63F 13/60; G06Q 30/0601; A63F 2300/5513; A63F 2300/638; A63F 2300/5546; G06F 11/3438

(57) ABSTRACT

Systems and methods are provided for generating game-related data associated with player purchase of virtual goods in a game by a plurality of players, selecting a subset of players from the plurality of players to purchase a limited amount of virtual goods, and determining player purchase behavior for the subset of players based on analyzing the game-related data associated with the player purchase of virtual goods by the subset of players. The systems and method further provide for generating an inventory amount of virtual goods to offer to the subset of players based on the player purchase behavior for the subset of players, causing the inventory amount of virtual goods to be displayed on a client device, and causing the inventory amount to decrease on the display of the client device in a non-linear pace.

### BACKGROUND

Virtual goods are non-physical objects used in online games or communities that have no monetary value. :For example, virtual goods may include currency in an online game, seeds or livestock in an online farming game, and so forth. Virtual goods may be purchased by game players for real money in the real world.

To achieve realistic in-game economics, the inventory of available items of different types of virtual goods is often limited. In such cases, inventory or world state information is typically maintained on a game server system. Due to technical realities of managing a game played by multiple players over a distributed computer network, there is often substantial lag between the purchase of virtual goods and updating of authoritative inventory information or game state information maintained by the game server system. In the meantime, however, published inventory information can require estimated updating to avoid the display of outdated inventory information to prospective buyers. These technical difficulties are not satisfactorily accounted for by existing mechanisms.

### BRIEF DESCRIPTION OF THE DRAWINGS

Various ones of the appended drawings merely illustrate example embodiments of the present disclosure and should not be considered as limiting its scope.

FIG. 1 is a schematic diagram showing an example of a system, according to some example embodiments.

FIG. 2 is a schematic diagram showing an example of a social network within a social graph, according to some embodiments.

FIG. 3 is a diagrammatic representation of an example data flow between example components of the example system of FIG. 1, according to some example embodiments.

FIG. 4 is a schematic diagram showing an example network environment, in which various example embodiments may operate, according to some example embodiments.

FIG. 5 illustrates an example computing system architecture, which may be used to implement one or more machines, according to some example embodiments.

FIG. 6 is a flowchart illustrating aspects of a method, according to some example embodiments.

FIG. 7 illustrates an example user interface, according to some example embodiments.

### DETAILED DESCRIPTION

Systems and methods described herein relate to estimating a real-time virtual goods inventory in a computer-implemented multiplayer gaming environment. When a user or player purchases virtual goods via a computing device (e.g., mobile device, such as a smart phone or tablet, personal computer, and the like) over a distributed computer network, it takes some time before a game server is updated about the sale. In one example, it can take up to fifteen minutes for the game server to be notified of a sale. In the example of a flash sale of virtual goods (e.g., where virtual goods may be sold for reduced prices for a limited period of time), there is a need to determine real-time (or near real-time) how may virtual goods are being sold in the time frame for the sale, or, worded differently, the quantity of virtual goods remaining of an initially limited offering. Example embodiments provide systems and methods for providing estimated real-time inventory information based on estimating a real-time rate of sale for virtual goods, since it is not possible to provide the inventory information real-time. The estimated rate of sale for virtual goods may be used in a variety of use case scenarios when a game wants to provide the number of virtual goods that are available. In one example, a limited sale of virtual goods can be enabled by generating an estimated inventory amount of the virtual goods to offer to one or more players based on game-related data associated with one or more players), and using the estimated inventory amount of the virtual goods to provide a countdown of goods still available in the limited sale.

Accordingly, example embodiments provide for generating game-related data associated with player purchase of virtual goods in a game by a plurality of players, selecting a subset of players from the plurality of players to purchase a limited amount of virtual goods, and analyzing the game-related data associated with the player purchase of virtual goods by the subset of players to determine player purchase behavior for the subset of players. Example embodiments further provide for generating an inventory amount of virtual goods to offer to the subset of players based on the player purchase behavior for the subset of players, causing the inventory amount of virtual goods to be displayed on a client device, and causing the inventory amount to decrease on the display of the client device in a non-linear pace.

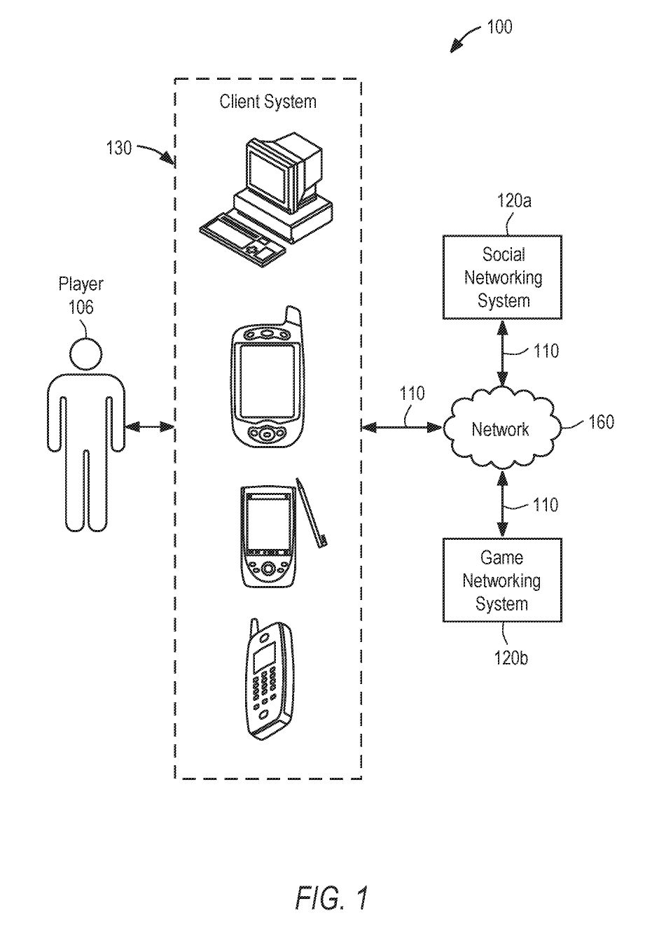

FIG. 1 illustrates an example of a system for implementing various disclosed embodiments. In particular embodiments, system 100 comprises player 106, social networking system 120a, game networking system 120b, client system 130, and network 160. The components of system 100 can be connected to each other in any suitable configuration, using any suitable type of connection. The components may be connected directly or over a network 160, which may be any suitable network. For example, one or more portions of network 160 may be an ad hoc network, an intranet, an extranet, a virtual private network (VPN), a local area. network (LAN), a wireless LAN (WLAN), a wide area network (WAN), a wireless WAN (WWAN), a metropolitan area network (MAN), a portion of the Internet, a portion of the Public Switched Telephone Network (PSTN), a cellular telephone network, another type of network, or a combination of two or more such networks.

Social networking system 120a is a network-addressable computing system that can host one or more social graphs. Social networking system 120a can generate, store, receive, and transmit social networking data. Social networking system 120a can be accessed by the other components of system 100 either directly or via network 160. Game networking system 120b is a network-addressable computing system that can host one or more online games. Game networking system 120b can generate, store, receive, and transmit game-related data, such as, for example, game account data, game input, game state data, and game displays. Game networking system 120b can be accessed by the other components of system 100 either directly or via network 160. Player 106 may use client system 130 to access, send data to, and receive data from social networking system 120a and game networking system 120b. Client system 130 can access social networking system 120a or game networking system 120b directly, via network 160, or via a third-party system. As an example, and not by way of limitation, client system 130 may access game networking system 120b via social networking system 120a, Client system 130 can be any suitable computing device, such as a personal computer, laptop, cellular phone, smart phone, computing tablet, and the like.

Although FIG. 1 illustrates a particular number of players 106, social networking systems 120a, game networking systems 120b, client systems 130, and networks 160, this disclosure contemplates any suitable number of players 106, social networking systems 120a, game networking systems 120b, client systems 130, and networks 160. As an example, and not by way of limitation, system 100 may include one or more game networking systems 120b and no social networking systems 120a, As another example, and not by way of limitation, system 100 may include a system that comprises both social networking system 120a and game networking system 120b. Moreover, although FIG illustrates a particular arrangement of player 106, social networking system 120a, game networking system 120b, client system 130, and network 160, this disclosure contemplates any suitable arrangement of player 106, social networking system 120a, game networking system 120b, client system 130, and network 160.

The components of system 100 may be connected to each other using any suitable connections 110. For example, suitable connections 110 include wireline (such as, for example, Digital Subscriber Line (DSL) or Data Over Cable Service Interface Specification (DOCSIS)), wireless (such as, for example, or Worldwide Interoperability for Microwave Access (WiMAX)) or optical (such as, for example, Synchronous Optical Network (SONET) or Synchronous Digital Hierarchy (SDH)) connections. In particular embodiments, one or more connections 110 each include an ad hoc network, an intranet, an extranet, a VPN, a LAN, a WLAN, a WAN, a WWAN, a MAN, a portion of the Internet, a portion of the PSTN, a cellular telephone network, another type of connection, or a combination of two or more such connections. Connections 110 need not necessarily be the same throughout system 100. One or more first connections 110 may differ in one or more respects from one or more second connections 110. Although FIG. 1 illustrates particular connections between player 106, social networking system 120a, game networking system 120b, client system 130, and network 160, this disclosure contemplates any suitable connections between player 106, social networking system 120a, game networking system 120b, client system 130, and network 160. As an example, and not by way of limitation, in particular embodiments, client system 130 may have a direct connection to social networking system 120a or game networking system 120b, bypassing network 160.

In an online computer game, a game engine manages the game state of the game. Game state comprises all game play parameters, including player character state, non-player character (NPC) state, in-game object state, game world state (e.g., internal game clocks, game environment), and other game play parameters. Each player 106 controls one or more player characters (PCs). The game engine controls all other aspects of the game, including non-player characters (NPCs) and in-game objects. The game engine also manages game state, including player character state for currently active (online) and inactive (offline) players.

An online game can be hosted by game networking system 120b, which can be accessed using any suitable connection with a suitable client system 130. A player 106) may have a game account on game networking system 120b, wherein the game account can contain a variety of information associated with the player (e.g., the player's personal information, financial information, purchase history, player character state, game state). In some embodiments, a player may play multiple games on game networking system 120b, which may maintain a single game account for the player with respect to all the games, or multiple individual game accounts for each game with respect to the player. In some embodiments, game networking system 120b can assign a unique identifier to each player 106 of an online game hosted on game networking system 1201) Game networking system 120b can determine that a player 106 is accessing the online game by reading the user's cookies, which may be appended to HTTP requests transmitted by client system 130, and/or by the player 106 logging onto the online game.

In particular embodiments, player 106 may access an online game and control the game's progress via client system 130 (e.g., by inputting commands to the game at the client device). Client system 130 can display the game interface, receive inputs from player 106, transmit user inputs or other events to the game engine, and receive instructions from the game engine. The game engine can be executed on any suitable system (such as, for example, client system 130, social networking system 120a, or game networking system 120b). As an example and not by way of limitation, client system 130 can download client components of an online game, which are executed locally, while a remote game server, such as game networking system 120b, provides backend support for the client components and may be responsible for maintaining application data of the game, processing the inputs from the player 106, updating and/or synchronizing the game state based on the game logic and each input from the player 106, and transmitting instructions to the client system 130. As another example and not by way of limitation, each time player 106 provides an input to the game through the client system 130 (such as, for example, by typing on the keyboard or clicking the mouse of client system 130), the client components of the game may transmit the player's input to the game networking system 120b.

In an online multiplayer game, players may control player characters (PCs), a game engine controls non-player characters (NPCs) and game features, and the game engine also manages player character state and game state and tracks the state for currently active (i.e., online) players and currently inactive (i.e., offline) players. A player character can have a set of attributes and a set of friends associated with the player character. As used herein, the term “player character state” can refer to any in-game characteristic of a player character, such as location, assets, levels, condition, health, status, inventory, skill set, name, orientation, affiliation, specialty, and so on. Player characters may be displayed as graphical avatars within a user interface of the game. In other implementations, no avatar or other graphical representation of the player character is displayed. Game state encompasses the notion of player character state and refers to any parameter value that characterizes the state of an in-game element, such as a non-player character, a virtual object (such as a wall or castle), and the like. The game engine may use player character state to determine the outcome of game events, sometimes also considering set or random variables. Generally, a player character's probability of having a more favorable outcome is greater when the player character has a better state. For example, a healthier player character is less likely to die in a particular encounter relative to a weaker player character or non-player character. In some embodiments, the game engine can assign a unique client identifier to each player.

In particular embodiments, player 106 may access particular game instances of an online game. A game instance is a copy of a specific game play area that is created during runtime. In particular embodiments, a game instance is a discrete game play area where one or more players 106 can interact in synchronous or asynchronous play. A game instance may be, for example, a level, zone, area, region, location, virtual space, or other suitable play area. A game instance may be populated by one or more in-game objects. Each object may be defined within the game instance by one or more variables, such as, for example, position, height, width, depth, direction, time, duration, speed, color, and other suitable variables. A game instance may be exclusive (i.e., accessible by specific players) or non-exclusive (i.e., accessible by any player). In particular embodiments, a game instance is populated by one or more player characters controlled by one or more players 106 and one or more in-game Objects controlled by the game engine. When accessing an online game, the game engine may allow player 106 to select a particular game instance to play from a plurality of game instances. Alternatively, the game engine may automatically select the game instance that player 106 will access. In particular embodiments, an online game comprises only one game instance that all players 106 of the online game can access.

In particular embodiments, a specific game instance may be associated with one or more specific players. A game instance is associated with a specific player when one or more game parameters of the game instance are associated with the specific player. As an example, and not by way of limitation, a game instance associated with a first player may be named “First Player's Play Area.” This game instance may be populated with the first player's PC and one or more in-game objects associated with the first player. In particular embodiments, a game instance associated with a specific player may only be accessible by that specific player. As an example, and not by way of limitation, a first player may access a first game instance when playing an online game, and this first game instance may be inaccessible to all other players. In other embodiments, a game instance associated with a specific player may be accessible by one or more other players, either synchronously or asynchronously with the specific player's game play. As an example, and not by way of limitation, a first player may be associated with a first game instance, but the first game instance may be accessed by all first-degree friends in the first player's social network. In particular embodiments, the game engine may create a specific game instance for a specific player when that player accesses the game. As an example, and not by way of limitation, the game engine may create a first game instance when a first player initially accesses an online game, and that same game instance may be loaded each time the first player accesses the game. As another example and not by way of limitation, the game engine may create a new game instance each time a first player accesses an online game, wherein each game instance may be created randomly or selected from a set of predetermined game instances. In particular embodiments, the set of in-game actions available to a specific player may be different in a game instance that is associated with that player compared to a game instance that is not associated with that player. The set of in-game actions available to a specific player in a game instance associated with that player may be a subset, superset, or independent of the set of in-game actions available to that player in a game instance that is not associated with him. As an example, and not by way of limitation, a first player may be associated with Blackacre Farm in an online farming game. The first player may be able to plant crops on Blackacre Farm. If the first player accesses a game instance associated with another player, such as Whiteacre Farm, the game engine may not allow the first player to plant crops in that game instance. However, other in-game actions may be available to the first player, such as watering or fertilizing crops on Whiteacre Farm.

In particular embodiments, a game engine can interface with a social graph. Social graphs are models of connections between entities (e.g., individuals, users, contacts, friends, players, player characters, non-player characters, businesses, groups, associations, concepts, etc.). These entities are considered “users” of the social graph; as such, the terms “entity” and “user” may be used interchangeably when referring to social graphs herein. A social graph can have a node for each entity and edges to represent relationships between entities. A node in a social graph can represent any entity. In particular embodiments, a unique client identifier can be assigned to each user in the social graph. This disclosure assumes that at least one entity of a social graph is a player or player character in an online multiplayer game, though this disclosure includes any suitable social graph users.

The minimum number of edges needed to connect a player (or player character) to another user is considered the degree of separation between them. For example, where the player and the user are directly connected (one edge), they are deemed to be separated by one degree of separation. The user would be a so-called “first-degree friend” of the player. Where the player and the user are connected through one other user (two edges), they are deemed to be separated by two degrees of separation. This user would be a so-called “second-degree friend” of the player. Where the player and the user are connected through N edges (or N-1 other users), they are deemed to be separated by N degrees of separation. This user would be a so-called “Nth-degree friend.” As used herein, the term “friend” means only first-degree friends, unless context suggests otherwise.

Within the social graph, each player (or player character) has a social network. A player's social network includes all users in the social graph within Nmax degrees of the player, where Nmax is the maximum degree of separation allowed by the system managing the social graph (such as, for example, social networking system 120a or game networking system 120b). In one embodiment, Nmax equals 1, such that the player's social network includes only first-degree friends. In another embodiment, Nmax is unlimited and the player's social network is coextensive with the social graph.

In particular embodiments, the social graph is managed by game networking system 120b, which is managed by the game operator. In other embodiments, the social graph is part of a social networking system 120a managed by a third party (e.g., Facebook, Friendster, Myspace). In yet other embodiments, player 106 has a social network on both game networking system 120b and social networking system 120a, wherein player 106 can have a social network on the game networking system 120b that is a subset, superset, or independent of the player's social network on social networking system 120a. In such combined systems, game networking system 120b can maintain social graph information with edge type attributes that indicate whether a given friend is an “in-game friend,” an “out-of-game friend,” or both. The various embodiments disclosed herein are operable when the social graph is managed by social networking system 120a, game networking system 120b, or both.

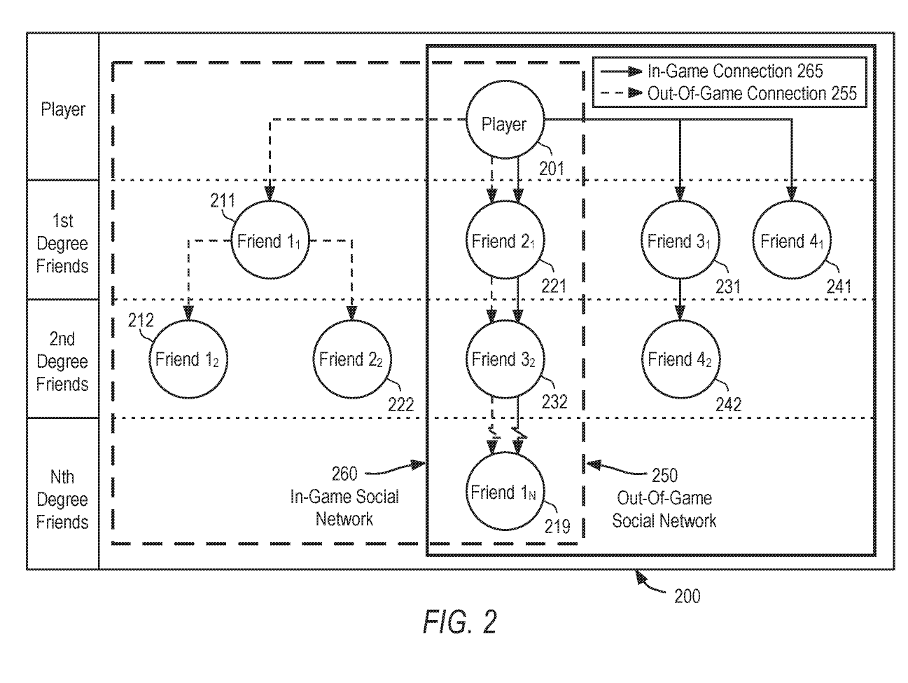

FIG. 2 shows an example of a social network 250 within a social graph. As shown, Player 201 can be associated, connected, or linked to various other users, or “friends,” within the social network 250. These associations, connections, or links can track relationships between users within the social network 250 and are commonly referred to as online “friends” or “friendships” between users. Each friend or friendship in a particular user's social network within a social graph is commonly referred to as a “node.” For purposes of illustration and not by way of limitation, the details of social network 250 will be described in relation to Player 201. As used herein, the terms “player” and “user” can be used interchangeably and can refer to any user or character in an online multiuser game system or social networking system. As used herein, the term “friend” can mean any node within a player's social network.

As shown in FIG. 2, Player 201 has direct connections with several friends. When Player 201 has a direct connection with another individual, that connection is referred to as a first-degree friend. In social network 250, Player 201 has two first-degree friends. That is, Player 201 is directly connected to Friend 1₁ 211 and Friend 2₁ 221. In a social graph, it is possible for individuals to be connected to other individuals through their first-degree friends (i.e., friends of friends). As described above, each edge required to connect a player to another user is considered the degree of separation. For example, FIG. 2 shows that Player 201 has three second-degree friends to which he is connected via his connection to his first-degree friends. Second-degree Friend 1₂ 212 and Friend 2₂ 222 are connected to Player 201 via his first-degree Friend 1₁ 211. The limit on the depth of friend connections, or the number of degrees of separation for associations, that Player 201 is allowed is typically dictated by the restrictions and policies implemented by social networking system 120a.

In various embodiments, Player 201 can have Nth-degree friends connected to him through a chain of intermediary degree friends as indicated in FIG. 2. For example, Nth-degree Friend 1_{N} 219 is connected to Player 201 via second-degree Friend 3₂ 232 and one or more other higher-degree friends. Various embodiments may take advantage of and utilize the distinction between the various degrees of friendship relative to Player 201.

In particular embodiments, a player (or player character) can have a social graph within an online multiplayer game that is maintained by the game engine and another social graph maintained by a separate social networking system. FIG. 2 depicts an example of in-game social network 260 and out-of-game social network 250. In this example, Player 201 has out-of-game connections 255 to a plurality of friends, forming out-of-game social network 250. Here, Friend 1₁ 211 and Friend 2₁ 221 are first-degree friends with Player 201 in his out-of-game social network 250. Player 201 also has in-game connections 265 to a plurality of players, forming in-game social network 260. Here, Friend 2₁ 221, Friend 3₁ 231, and Friend 4₁ 241 are first-degree friends with Player 201 in his in-game social network 260. In some embodiments, it is possible for a friend to be in both the out-of-game social network 250 and the in-game social network 260. Here, Friend 2₁ 221 has both an out-of-game connection 255 and an in-game connection 265 with Player 201, such that Friend 2₁ 221 is in both Player 201's in-game social network 260 and Player 201's out-of-game social network 250.

As with other social networks, Player 201 can have second-degree and higher-degree friends in both his in-game and out-of-game social networks. In some embodiments, it is possible for Player 201 to have a friend connected to him both in his in-game and out-of-game social networks, wherein the friend is at different degrees of separation in each network. For example, if Friend 2₂ 222 had a direct in-game connection with Player 201, Friend 2₂ 222 would be a second-degree friend in Player 201's out-of-game social network, but a first-degree friend in Player 201's in-game social network. In particular embodiments, a game engine can access in-game social network 260, out-of-game social network 250, or both.

In particular embodiments, the connections in a player's in-game social network can be formed both explicitly (e.g., users must “friend” each other) and implicitly (e.g., system observes user behaviors and “friends” users to each other). Unless otherwise indicated, reference to a friend connection between two or more players can be interpreted to cover both explicit and implicit connections, using one or more social graphs and other factors to infer friend connections. The friend connections can be unidirectional or bidirectional. It is also not a limitation of this description that two players who are deemed “friends” for the purposes of this disclosure are not friends in real life (i.e., in di sintermediated interactions or the like), but that could be the case.

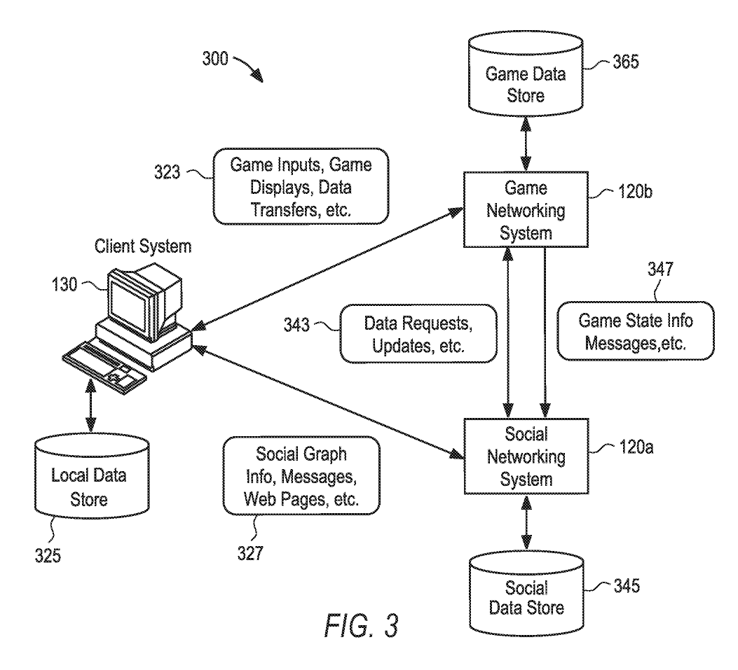

FIG. 3 illustrates an example data flow between the components of system 300. In particular embodiments, system 300 can include client system 130, social networking system 120a, and game networking system 120b. The components of system 300 can be connected to each other in any suitable configuration, using any suitable type of connection. The components may be connected directly or over any suitable network. Client system 130, social networking system 120a, and game networking system 120b can each have one or more corresponding data stores such as local data store 325, social data store 345, and game data store 365, respectively. The local data store 325 and game data store 365 contains player-based information that may be used to determine the difficulty level for the specific player. Social networking system 120a and game networking system 120b can also have one or more servers that can communicate with client system 130 over an appropriate network. Social networking system 120a and game networking system 120b can have, for example, one or more Internet servers for communicating with client system 130 via the Internet. Similarly, social networking system 120a and game networking system 11.20b can have one or more mobile servers for communicating with client system 130 via a mobile network (e.g., GSM, PCS, WPAN, etc.). In some embodiments, one server may be able to communicate with client system 130 over both the Internet and a mobile network. In other embodiments, separate servers can be used.

Client system 130 can receive and transmit data 323 to and from game networking system 120b. This data can include, for example, webpages, messages, game inputs, game displays, HTTP packets, data requests, transaction information, updates, and other suitable data. At some other time, or at the same time, game networking system 120b can communicate data 343, 347 (e.g., game state information, game system account information, page info, messages, data requests, updates, etc.) with other networking systems, such as social networking system 120a (e.g., Facebook, Myspace, etc.). Client system 130 can also receive and transmit data 327 to and from social networking system 120a. This data can include, for example, webpages, messages, social graph information, social network displays, HTTP packets, data requests, transaction information, updates, and other suitable data.

Communication between client system 130, social networking system 120a, and game networking system 120b can occur over any appropriate electronic communication medium or network using any suitable communications protocols. For example, client system 130, as well as various servers of the systems described herein, may include Transport Control Protocol/Internet Protocol (TCP/IP) networking stacks to provide for datagram and transport functions. Of course, any other suitable network and transport layer protocols can be utilized.

In addition, hosts or end-systems described herein may use a variety of higher layer communications protocols, including client-server (or request-response) protocols, such as the HyperText Transfer Protocol (HTTP) and other communications protocols, such as HTTP-S, FTP, SNMP, TELNET, and a number of other protocols, may be used in addition, a server in one interaction context may be a client in another interaction context. In particular embodiments, the information transmitted between hosts may be formatted as HyperText Markup Language (HTML) documents. Other structured document languages or formats can be used, such as XML, and the like. Executable code objects, such as JavaScript and ActionScript, can also be embedded in the structured documents.

In some client-server protocols, such as the use of HTML over HTTP, a server generally transmits a response to a request from a client. The response may comprise one or more data objects. For example, the response may comprise a first data object, followed by subsequently transmitted data objects. In particular embodiments, a client request may cause a server to respond with a first data object, such as an HTML page, which itself refers to other data objects. A client application, such as a browser, will request these additional data objects as it parses or otherwise processes the first data object.

In particular embodiments, an instance of an online game can be stored as a set of game state parameters that characterize the state of various in-game objects, such as, for example, player character state parameters, non-player character parameters, and virtual item parameters. In particular embodiments, game state is maintained in a database as a serialized, unstructured string of text data as a so-called Binary Large Object (BLOB). When a player accesses an online game on game networking system 120b, the BLOB containing the game state for the instance corresponding to the player can be transmitted to client system 130 for use by a client-side executed object to process. In particular embodiments, the client-side executable may be a FLASH-based game, which can de-serialize the game state data in the BLOB. As a player plays the game, the game logic implemented at client system 130 maintains and modifies the various game state parameters locally. The client-side game logic may also batch game events, such as mouse clicks, and transmit these events to game networking system 120b. Game networking system 120b may itself operate by retrieving a copy of the BLOB from a database or an intermediate memory cache (memcache) layer. Game networking system 120b can also de-serialize the BLOB to resolve the game state parameters and execute its own game logic based on the events in the batch file of events transmitted by the client to synchronize the game state on the server side. Game networking system 120b may then re-serialize the game state, now modified, into a BLOB and pass this to a memory cache layer for lazy updates to a persistent database.

With a client-server environment in which the online games may run, one server system, such as game networking system 120b, may support multiple client systems 130. At any given time, there may be multiple players at multiple client systems 130 all playing the same online game. In practice, the number of players playing the same game at the same time may be very large. As the game progresses with each player, multiple players may provide different inputs to the online game at their respective client systems 130, and multiple client systems 130 may transmit multiple player inputs and/or game events to game networking system 120b for further processing. In addition, multiple client systems 130 may transmit other types of application data to game networking system 120b.

In particular embodiments, a computer-implemented game may be a text-based or turn-based game implemented as a series of web pages that are generated after a player selects one or more actions to perform. The web pages may be displayed in a browser client executed on client system 130. As an example, and not by way of limitation, a client application downloaded to client system 130 may operate to serve a set of web pages to a player. As another example and not by way of limitation, a computer-implemented game may be an animated or rendered game executable as a stand-alone application or within the context of a web page or other structured document. In particular embodiments, the computer-implemented game may be implemented using Adobe Flash-based technologies. As an example, and not by way of limitation, a game may be fully or partially implemented as a SWF object that is embedded in a web page and executable by a Flash media player plug-in. In particular embodiments, one or more described web pages may be associated with or accessed by social networking system 120a. This disclosure contemplates using any suitable application for the retrieval and rendering of structured documents hosted by any suitable network-addressable resource or website.

Application event data of a game is any data relevant to the game (e.g., player inputs). In particular embodiments, each application datum may have a name and a value, and the value of the application datum may change (i.e., be updated) at any time. When an update to an application datum occurs at client system 130, either caused by an action of a game player or by the game logic itself, client system 130 may need to inform game networking system 120b of the update. For example, if the game is a farming game with a harvest mechanic (such as Zynga FarmVille®), an event can correspond to a player clicking on a parcel of land to harvest a crop. In such an instance, the application event data may identify an event or action (e.g., harvest) and an object in the game to which the event or action applies. For illustration purposes and not by way of limitation, system 300 is discussed in reference to updating a multi-player online game hosted on a network-addressable system (such as, for example, social networking system 120a or game networking system 120b ), where an instance of the online game is executed remotely on a client system 130. Which then transmits application event data to the hosting system such that the remote game server synchronizes game state associated with the instance executed by the client system 130.

In a particular embodiment, one or more objects of a game may be represented as an Adobe Flash object. Flash may manipulate vector and raster graphics, and supports bidirectional streaming of audio and video. “Flash” may mean the authoring environment, the player, or the application files. In particular embodiments, client system 130 may include a Flash client. The Flash client may be configured to receive and run Flash application or game object code from any suitable networking system (such as, for example, social networking system 120a or game networking system 120b). In particular embodiments, the Flash client may be run in a browser client executed on client system 130. A player can interact with Flash objects using client system 130 and the Flash client. The Flash objects can represent a variety of in-game objects. Thus, the player may perform various in-game actions on various in-game objects by making various changes and updates to the associated Flash objects. In particular embodiments, in-game actions can be initiated by clicking or similarly interacting with a Flash object that represents a particular in-game object. For example, a player can interact with a Flash object to use, move, rotate, delete, attack, shoot, or harvest an in-game object. This disclosure contemplates performing any suitable in-game action by interacting with any suitable Flash object. In particular embodiments, when the player makes a change to a Flash object representing an in-game object, the client-executed game logic may update one or more game state parameters associated with the in-game object. To ensure synchronization between the Flash object shown to the player at client system 130, the Flash client may send the events that caused the game state changes to the in-game object to game networking system 120b. However, to expedite the processing and hence the speed of the overall gaming experience, the Flash client may collect a batch of some number of events or updates into a batch file. The number of events or updates may be determined by the Flash client dynamically or determined by game networking system 120b based on server loads or other factors. For example, client system 130 may send a batch file to game networking system 120b whenever 50 updates have been collected or after a threshold period of time, such as every minute.

As used herein, the term “application event data” may refer to any data relevant to a computer-implemented game application that may affect one or more game state parameters, including, for example and without limitation, changes to player data or metadata, changes to player social connections or contacts, player inputs to the game, and events generated by the game logic. In particular embodiments, each application datum may have a name and a value. The value of an application datum may change at any time in response to the game play of a player or in response to the game engine (e.g., based on the game logic). In particular embodiments, an application data update occurs when the value of a specific application datum is changed. In particular embodiments, each application event datum may include an action or event name and a value (such as an object identifier). Thus, each application datum may be represented as a name-value pair in the batch file. The batch file may include a collection of name-value pairs representing the application data that have been updated at the client system 130. In particular embodiments, the batch file may be a text file and the name-value pairs may be in string format.

In particular embodiments, when a player plays an online game on the client system 130, the game networking system 120b may serialize all the game-related data, including, for example and without limitation, game states, game events, user inputs, for this particular user and this particular game, into a BLOB and store the BLOB in a database. The BLOB may be associated with an identifier that indicates that the BLOB contains the serialized game-related data for a particular player and a particular online game. In particular embodiments, while a player is not playing the online game, the corresponding BLOB may be stored in the database. This enables a player to stop playing the game at any time without losing the current state of the game the player is in. When a player resumes playing the game next time, the game networking system 120b may retrieve the corresponding BLOB from the database to determine the most recent values of the game-related data. In particular embodiments, while a player is playing the online game, the game networking system 120b may also load the corresponding BLOB into a memory cache so that the game system may have faster access to the BLOB and the game-related data contained therein.

In particular embodiments, one or more described webpages may be associated with a networking system or networking service. However, alternate embodiments may have application to the retrieval and rendering of structured documents hosted by any type of network addressable resource or web site. Additionally, as used herein, a user may be an individual, a group, or an entity (such as a business or third party application).

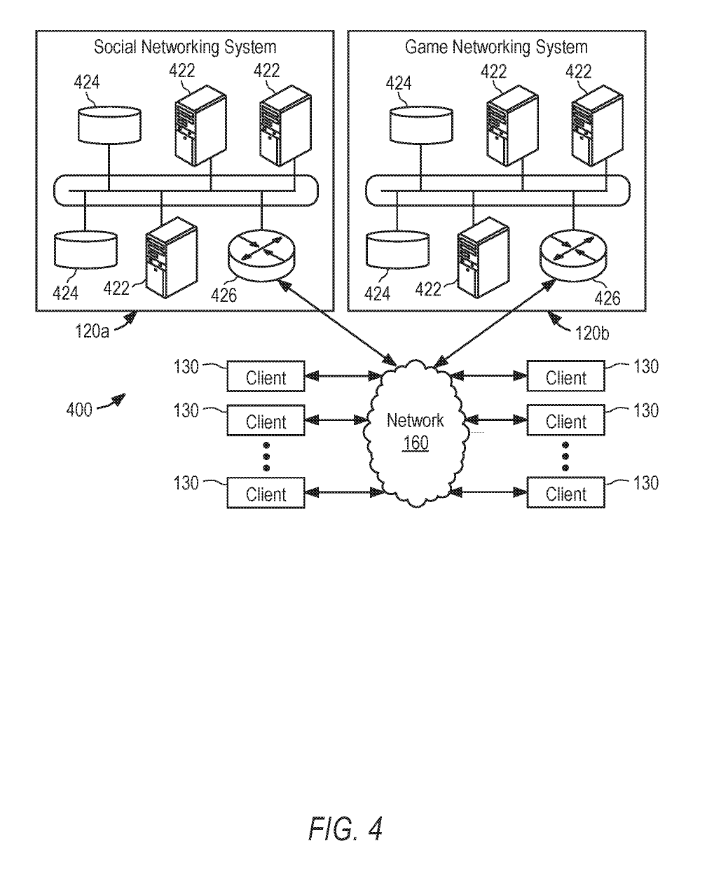

Particular embodiments may operate in a wide area network environment, such as the :Internet, including multiple network addressable systems. FIG. 4 illustrates an example network environment 400, in which various example embodiments may operate. Network cloud 160 generally represents one or more interconnected networks, over which the systems and hosts described herein can communicate. Network cloud 160 may include packet-based wide area networks (such as the Internet), private networks, wireless networks, satellite networks, cellular networks, paging networks, and the like. As FIG. 4 illustrates, particular embodiments may operate in a network environment 400 comprising one or more networking systems, such as social networking system 120a, game networking system 120b, and one or more client systems 130. The components of social networking system 120a and game networking system 120b operate analogously; as such, hereinafter they may be referred to simply as networking system 120. Client systems 130 are operably connected to the network environment 400 via a network service provider, a wireless carrier, or any other suitable means.

Networking system 12.0 is a network addressable system that, in various example embodiments, comprises one or more physical servers 422 and data stores 424. The one or more physical servers 422 are operably connected to computer network 160 via, by way of example, a set of routers and/or networking switches 426. In an example embodiment, the functionality hosted by the one or more physical servers 422 may include web or HTTP servers, FTP servers, as well as, without limitation, web pages and applications implemented using Common Gateway Interface (CGI) script, PHP Flyper-text Preprocessor (PHP), Active Server Pages (ASP), Hyper Text Markup Language (HTML), Extensible Markup Language (XML), Java, JavaScript, Asynchronous JavaScript and XML (AJAX), Hash, ActionScript, and the like.

Physical servers 422 may host functionality directed to the operations of networking system 120. Hereinafter servers 422 may be referred to as server 422, although server 422 may include numerous servers hosting, for example, networking system 120, as well as other content distribution servers, data stores, and databases. Data store 424 may store content and data relating to, and enabling, operation of networking system 120 as digital data objects. A data object, in particular embodiments, is an item of digital information typically stored or embodied in a data file, database, or record. Content objects may take many forms, including: text (e.g., ASCII, SGML, HTML), images (e.g., jpeg, tif and gif), graphics (vector-based or bitmap), audio, video (e.g., mpeg), or other multimedia, and combinations thereof Content object data may also include executable code objects (e.g., games executable within a browser window or frame), podcasts, and the like. Logically, data store 424 corresponds to one or more of a variety of separate and integrated databases, such as relational databases and object-oriented databases, that maintain information as an integrated collection of logically related records or files stored on one or more physical systems. Structurally, data store 424 may generally include one or more of a large class of data storage and management systems. In particular embodiments, data store 424 may be implemented by any suitable physical system(s) including components, such as one or more database servers, mass storage media, media library systems, storage area networks, data storage clouds, and the like. In one example embodiment, data store 424 includes one or more servers, databases (e.g., MySQL), and/or data warehouses. Data store 424 may include data associated with different networking system 120 users and/or client systems 130.

Client system 130 is generally a computer or computing device including functionality for communicating (e.g., remotely) over a computer network. Client system 130 may be a desktop computer, laptop computer, personal digital assistant (PDA), in- or out-of-car navigation system, smart phone or other cellular or mobile phone, or mobile gaming device, among other suitable computing devices. Client system 130 may execute one or more client applications, such as a web browser (e.g., Microsoft Internet Explorer, Mozilla Firefox, Apple Safari, Google Chrome, and Opera), to access and view content over a computer network. In particular embodiments, the client applications allow a user of client system 130 to enter addresses of specific network resources to be retrieved, such as resources hosted by networking system 120. These addresses can be Uniform Resource Locators (URLs) and the like. In addition, once a page or other resource has been retrieved, the client applications may provide access to other pages or records when the user “clicks” on hyperlinks to other resources. By way of example, such hyperlinks may be located within the web pages and provide an automated way for the user to enter the URL of another page and to retrieve that page.

A web page or resource embedded within a web page, which may itself include multiple embedded resources, may include data records, such as plain textual information, or more complex digitally encoded multimedia content, such as software programs or other code objects, graphics, images, audio signals, videos, and so forth. One prevalent markup language for creating web pages is the Hypertext Markup Language (HTML). Other common web browser-supported languages and technologies include the Extensible Markup Language (XML), the Extensible Hypertext Markup Language (XHTML), JavaScript, Flash, ActionScript, Cascading Style Sheet (CSS), and, frequently, Java. By way of example, HTML enables a page developer to create a structured document by denoting structural semantics for text and links, as well as images, web applications, and other objects that can be embedded within the page. Generally, a web page may be delivered to a client as a static document; however, through the use of web elements embedded in the page, an interactive experience may be achieved with the page or a sequence of pages. During a user session at the client, the web browser interprets and displays the pages and associated resources received or retrieved from the website hosting the page, as well as, potentially, resources from other websites.

When a user at a client system 130 desires to view a particular web page (hereinafter also referred to as target structured document) hosted by networking system 120, the user's web browser, or other document rendering engine or suitable client application, formulates and transmits a request to networking system 120. The request generally includes a URI, or other document identifier as well as metadata or other information. By way of example, the request may include information identifying the user, such as a user ID, as well as information identifying or characterizing the web browser or operating system running on the user's client computing device 130. The request may also include location information identifying a geographic location of the user's client system or a logical network location of the user's client system. The request may also include a timestamp identifying when the request was transmitted.

Although the example network environment described above and illustrated in FIG. 4 is described with respect to social networking system 120a and game networking system 120b, this disclosure encompasses any suitable network environment using any suitable systems. As an example and not by way of limitation, the network environment may include online media systems, online reviewing systems, online search engines, online advertising systems, or any combination of two or more such systems.

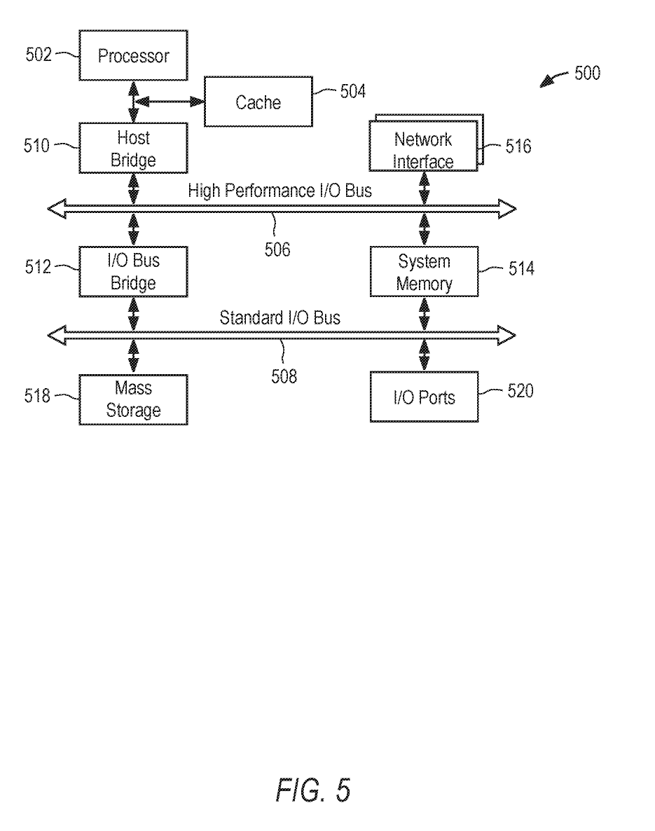

FIG. 5 illustrates an example computing system architecture, which may be used to implement a server 422 or a client system 130. In one embodiment, hardware system 500 comprises a processor 502, a cache memory 504, and one or more executable modules and drivers, stored on a tangible computer readable medium, directed to the functions described herein. Additionally, hardware system 500 may include a high performance input/output (I/O) bus 506 and a standard I/O bus 508. A host bridge 510 may couple processor 502 to high performance I/O bus 506, whereas I/O bus bridge 512 couples the two buses 506 and 508 to each other. A system memory 514 and one or more network/communication interfaces 516 may couple to bus 506. Hardware system 500 may further include video memory (not shown) and a display device coupled to the video memory. Mass storage 518 and I/O ports 520 may couple to bus 508. Hardware system 500 may optionally include a keyboard, a pointing device, and a display device (not shown) coupled to bus 508. Collectively, these elements are intended to represent a broad category of computer hardware systems, including but not limited to general purpose computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

The elements of hardware system 500 are described in greater detail below. In particular, network interface 516 provides communication between hardware system 500 and any of a wide range of networks, such as an Ethernet (e.g., IEEE 802.3) network, a backplane, and so forth. Mass storage 518 provides permanent storage for the data and programming instructions to perform the above-described functions implemented in servers whereas system memory 514 (e.g., DRAM) provides temporary storage for the data and programming instructions when executed by processor 502. I/O ports 520 are one or more serial and/or parallel communication ports that provide communication between additional peripheral devices, which may be coupled to hardware system 500.

Hardware system 500 may include a variety of system architectures and various components of hardware system 500 may be rearranged. For example, cache 504 may be on-chip with processor 502. Alternatively, cache 504 and processor 502 may be packed together as a “processor module,” with processor 502 being referred to as the “processor core.” Furthermore, certain embodiments of the present disclosure may not require or include all of the above components. For example, the peripheral devices shown coupled to standard I/O bus 508 may couple to high performance I/O bus 506. In addition, in some embodiments, only a single bus may exist, with the components of hardware system 500 being coupled to the single bus. Furthermore, hardware system 500 may include additional components, such as additional processors, storage devices, or memories.

An operating system manages and controls the operation of hardware system 500, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft (r) Windows(r) operating systems, BSD operating systems, and the like. Of course, other embodiments are possible. For example, the functions described herein may be implemented in firmware or on an application-specific integrated circuit.

Furthermore, the above-described elements and operations can be comprised of instructions that are stored on non-transitory storage media. The instructions can be retrieved and executed by a processing system. Some examples of instructions are software, program code, and firmware. Some examples of non-transitory storage media are memory devices, tape, disks, integrated circuits, and servers. The instructions are operational when executed by the processing system to direct the processing system to operate in accord with the disclosure. The term “processing system” refers to a single processing device or a group of inter-operational processing devices. Some examples of processing devices are integrated circuits and logic circuitry. Those skilled in the art are familiar with instructions, computers, and storage media.

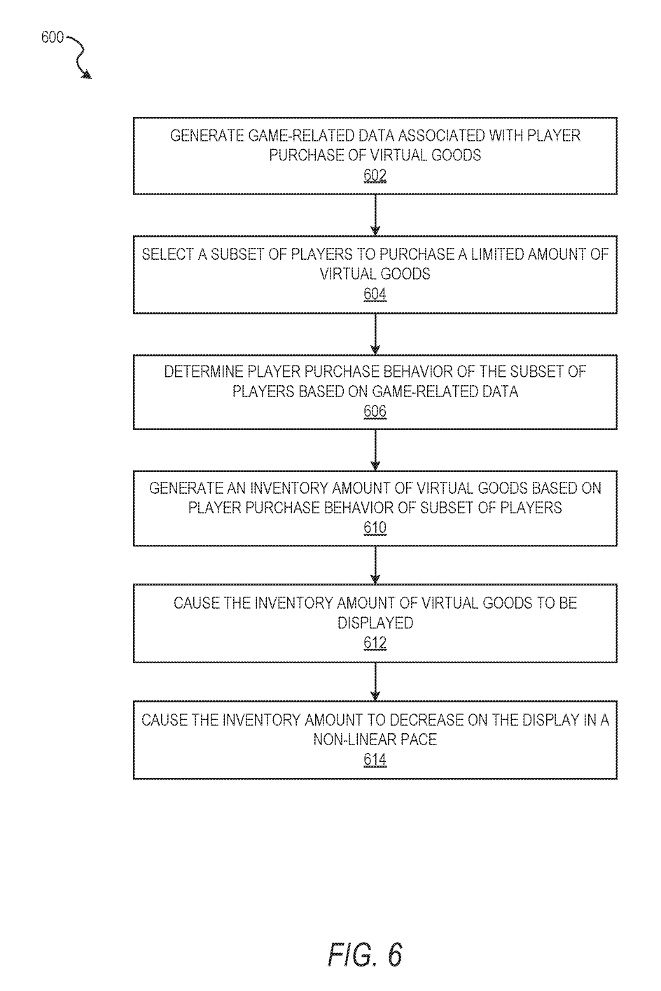

FIG. 6 is a flow chart illustrating aspects of a method 600, according to sonic example embodiments. For illustrative purposes, method 600 is described with respect to the networked system 100 of FIG. 1 and networked system 400 of FIG. 4. It is to be understood that method 600 may be practiced with other system configurations in other embodiments.

In operation 602, a computing device (e.g., a server computer 422 in game networking system 120b), generates game-related data associated with player purchase of virtual goods in a game by a plurality of players. In one example, the computing device may generate the game-related data by receiving and storing game-related data from a plurality of client devices upon which various games have been installed and played. The game-related data may comprise a player's in-game performance in one or more games in-game decisions, in-game moves, transaction history, overall game usage, virtual goods account balance, etc.). The game-related data may further comprise data associated with each player (e.g., age, race, gender, geographic location(s), device type, social networking connections (e.g., “friends”), etc.). The game-related data may further comprise virtual goods purchase information for each player of the plurality of players in one more databases. The virtual goods purchase information for each player may be game-specific (e.g., for a particular game) or may be purchase information for the player across more than one game. The purchase information may contain data such as a date and time the purchase was made, the quantity of virtual goods purchased, the weather at the time of purchase, the location of the computing device at the time of purchase, the amount of money spent on the purchase of the virtual goods, and so forth.

In operation 604, the computing device selects a subset of players from the plurality of players to purchase a limited amount of virtual goods. In one example, the computing device may determine which subset of players to select by analyzing game-related data for each player of the plurality of players to determine players that have a low balance of virtual goods (and thus, may need to soon purchase more virtual goods). For example, the computing device may check a virtual currency or goods wallet (e.g., inventory) go see how many virtual goods the player currently has. In one example, a low balance may be determined based on a balance being below a predetermined threshold. The predetermined threshold may be the same across all players for a particular game or may be specific to a player. For example, it may make sense that a low balance is a predetermined amount after which the player may not be able to advance further in a game or make more meaningful play in the game. In one example, the game could be a betting game and based on the balance of the player's virtual goods and the rate of spend (e.g., the amount the player is betting and how quickly the player is betting/playing), the low balance could be the amount in which the player will not be able to continue playing the game because he will no longer have enough virtual goods or currently to continue making bets.

In one example, the computing system may determine a subset of players that have a low balance of virtual goods that also have a similar spending behavior of virtual goods. In one example, the computing device may determine whether players with a low balance of virtual goods have a similar spending behavior of virtual goods by analyzing a predetermined amount of recent transactions (e.g., five transactions, ten transactions, purchases over the last day, week, or month, etc.) to determine whether recent transactions for each player comprise a similar range of an average dollar amount spent on virtual goods. For example, players may be segmented into groups of values (e.g., average dollar amount spent on the virtual goods), such as 0-5, 5-10, 10-20, 20-35, 35-50, 50-80, 80-150, and 150 and above, in one example. The computing device may analyze each of the recent transactions and determine that a subset of the players that have a low balance of virtual goods fall into the segment of $20-$35 average dollar amount spent on virtual goods in the recent transactions. The computing device may select the subset of players that has the low balance of virtual goods and are in the $20-$35 segment to purchase (or offer to purchase) a limited amount of virtual goods (e.g., select the subset of players that have a low balance of virtual goods and similar spending behavior of virtual goods as the subset of players from the plurality of players to purchase a limited amount of virtual goods).

In one example, the price offered to the subset of players for the limited amount of virtual goods (e.g., for each good, for a package of goods, etc.) may be affected by one or more of the following: whether or not a player has paid before, how long the player has played a game, how far advanced the player is in the game, player skill level, likelihood to chum, the overall game economy, the availability of a virtual item, the usefulness of a virtual item, or other player or game behaviors or other factors allowable under applicable laws. The computing system may generate the price to offer based on one or more of these (or other) factors and use the generated price to display to the subset of users.

In operation 606, the computing device determines player purchase behavior for the subset of players based on analyzing the game-related data associated with the player purchase of virtual goods by the subset of players. In one example, the computing device may determine player purchase related data from the game-related data associated with player purchase of virtual goods. In one example, the computing device may extract the player purchase-related data from game-related data to use to determine player purchase behavior. As described above, purchase-related data may comprise previous purchases made by the player, time of day of purchases made by the player, day of the week of purchases made by the player, time of the year of purchases made by the player, a location of purchase, and so forth. The computing device may use this purchase-related data (and other game-related data) to determine player purchase behavior, such as a rate of spend, the likelihood of a player to make a purchase, and so forth. For example, the computing device may determine that a particular player or a segment of players is 80% more likely to buy more inventory when it is a cold snowy day (e.g., because the player is inside playing games), or at a certain time of the day, or because the player is almost out of inventory, and so forth.

In operation 610, the computing device generates an inventory amount of virtual goods to be displayed on a client device to a player, based on the player purchase behavior for the subset of players. In one example, a machine learning model may be trained on game-related data and used to predict an amount of inventory based on the player purchase behavior for the subset of players. For example, extracted player purchase-related game data for the subset of players may be input into the machine learning model trained to predict the inventory amount of virtual goods for a subset of players based on the player purchase-related data. The machine learning model may determine how many packages to offer, and to whom, based on checking the virtual wallet (inventory) that the player currently has, a rate of spend for each player, and past spend behavior to check the likelihood of a player to make a purchase. The output from the machine learning model is an amount of inventory that the players are likely to purchase, e.g., based on the balance of virtual goods the user currently has, rate of spend, and past behavior.

In one example, the same or alternate model could be used to both determine the subset of players to which to offer the virtual goods and to determine an inventory amount to offer to the subset of players. The choice of model may be based upon assessing against previously used models. The computing device may alternate models using our machine learning system in order to identify that best-fitting model for the ultimate goal, which in example embodiments may be motivating a purchase within a certain time period. The computing device can identify a model that will identify a subset of players who will receive a sale offer. For example, if the computing device identifies a specific price point and rate of spend that optimizes for a certain group of players, the computing device may activate this feature accordingly. The model could identify a different group of players that will react to a different rate of spend, which the computing device will then surface to that different group. The machine learning system may be always identifying segmentations to optimize.

In one example, the computing device may use the amount output by the machine learning model as the amount of inventory to offer to the subset of players. In another example, the computing device may decrease the output inventory amount by a predetermined about (e.g., 20-25%, 1000 units, 10 packages, etc.) to generate the inventory amount of virtual goods to offer the subset of players.

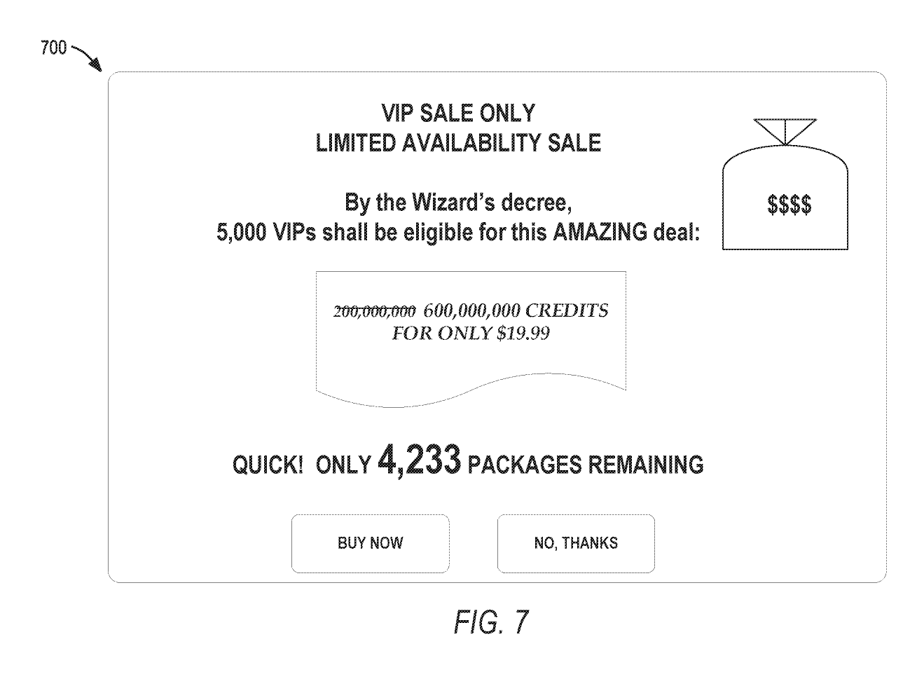

In operation 612, the computing device may cause the inventory amount of virtual goods to be displayed on a client device (e.g., client system 130). For example, FIG. 7 shows an example user interface 700 that may be displayed on a client device. The user interface may indicate a number of inventory (e.g., packages) that are offered for a limited time for a particular price (e.g., $19.99).

Returning to FIG. 6, in operation 614 the computing device may cause the inventory amount to decrease on the display of the client device in a non-linear pace or rate. In one example, the computing system may utilize an easing function to specify the rate of change of the inventory amount over time. In this way the computing device may decrease the inventory amount in a non-linear based on the easing function specifying the rate of change of the inventory over time. In one example, a random factor is added to the easing function to cause the inventory amount to decrease in a random pattern in order to appear truer to how the inventory may actually be decreasing. One example easing function that may be used is: Num-items-left=total-items * per * per * (3.0-2.0* per), where ‘per’ is the simple percentage of time passed with a small offset to make the numbers move interestingly.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Although an overview of the inventive subject matter has been described with reference to specific example embodiments, various modifications and changes may be made to these embodiments without departing from the broader scope of embodiments of the present disclosure.

The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

What is claimed is:

1. A method comprising:
generating, by a server computer, game-related data associated with player purchase of virtual goods in a game by a plurality of players;
selecting, by the server computer, a subset of players from the plurality of players to purchase a limited amount of virtual goods;
determining, by the server computer, player purchase behavior for the subset of players based on analyzing the game-related data associated with the player purchase of virtual goods by the subset of players;
generating, by the server computer, an inventory amount of virtual goods to offer to the subset of players based on the player purchase behavior for the subset of players;
causing, by the server computer, the inventory amount of virtual goods to be displayed on a client device;
causing, by the server computer, the inventory amount to decrease on the display of the client device in a non-linear pace.

2. The method of claim 1, wherein selecting the subset of players from the plurality of players to purchase a limited amount of virtual goods comprises:
analyzing game-related data for each player of the plurality of players to determine players that have a low balance of virtual goods;
determining a subset of the players that have a low balance of virtual goods that have similar spending behavior of virtual goods;
selecting the subset of the players that have a low balance of virtual goods and similar spending behavior of virtual goods as the subset of players from the plurality of players to purchase a limited amount of virtual goods.

3. The method of claim 2, wherein determining the subset of players that have similar spending behavior of virtual goods comprises:
analyzing a predetermined amount of recent transactions for each player; and
determining that the recent transactions comprise a similar range of average dollar amount spent on virtual goods.

4. The method of claim 1, wherein determining player purchase behavior for the subset of players based on analyzing the game-related data associated with the player purchase of virtual goods by the subset of players comprises determining player purchase-related data from the game-related data associated with player purchase of virtual goods and extracting the player purchase-related data from the game-related data.

5. The method of claim 4, wherein the purchase-related data comprises at least one of a group comprising: previous purchases made by a player, time of day of purchases made by the player, day of the week of purchases made by the player, time of the year of purchases made by the player, and location of purchase.

6. The method of claim 4, wherein generating the inventory amount of virtual goods to offer to the subset of players based on the player purchase behavior for the subset of players comprises:
inputting the extracted player purchase-related data for the subset of players into a machine learning model trained to predict an inventory amount of virtual goods for the subset of players based on player purchase-related data; and
receiving an output from the machine learning model of the inventory amount.

7. The method of claim 6, further comprising:
decreasing the output inventory amount by a predetermined amount to generate the inventory amount of virtual goods to offer to the subset of players.

8. The method of claim 1, the inventory amount to decrease on the display of the client device in a non-linear pace based on an easing function specifying a rate of change of the inventory over time.

9. The method of claim 1, wherein a random factor is added to the easing function to cause the inventory amount to decrease in a random pattern.

10. A server computer comprising:
one or more processors; and
a computer readable medium coupled with the one or more processors, the computer readable medium comprising instructions stored thereon that are executable by the one or more processors to cause a computing device to perform operations comprising:
generating game-related data associated with player purchase of virtual goods in a game by a plurality of players;
selecting a subset of players from the plurality of players to purchase a limited amount of virtual goods;
determining player purchase behavior for the subset of players based on analyzing the game-related data associated with the player purchase of virtual goods by the subset of players
generating an inventory amount of virtual goods to offer to the subset of players based on the player purchase behavior for the subset of players;
causing the inventory amount of virtual goods to be displayed on a client device;
causing the inventory amount to decrease on e display of the client device in a non-linear pace.

11. The server computer of claim 10, wherein selecting the subset of players from the plurality of players to purchase a limited amount of virtual goods comprises:
analyzing game-related data for each player of the plurality of players to determine players that have a low balance of virtual goods;
determining a subset of the players that have a low balance of virtual goods that have similar spending behavior of virtual goods;
selecting the subset of the players that have a low balance of virtual goods and similar spending behavior of virtual goods as the subset of players from the plurality of players to purchase a limited amount of virtual goods.

12. The server computer of claim 11, wherein determining the subset of players that have similar spending behavior of virtual goods comprises:
analyzing a predetermined amount of recent transactions for each player; and
determining that the recent transactions comprise a similar range of average dollar amount spent on virtual goods.

13. The server computer of claim 10, wherein determining player purchase behavior for the subset of players based on analyzing the game-related data associated with the player purchase of virtual goods by the subset of players comprises determining player purchase-related data from the game-related data associated with player purchase of virtual goods and extracting the player purchase-related data from the game-related data.

14. The server computer of claim 13, wherein the purchase-related data comprises at least one of a group comprising: previous purchases made by a player, time of day of purchases made by the player, day of the week of purchases made by the player, time of the year of purchases made by the player, and location of purchase.

15. The server computer of claim 13, wherein generating the inventory amount of virtual goods to offer to the subset of players based on the player purchase behavior for the subset of players comprises:
inputting the extracted player purchase-related data for the subset of players into a machine learning model trained to predict an inventory amount of virtual goods for the subset of players based on player purchase-related data; and
receiving an output from the machine learning model of the inventory amount.

16. The server computer of claim 15, further comprising:
decreasing the output inventory amount by a predetermined amount to generate the inventory amount of virtual goods to offer to the subset of players.

17. The server computer of claim 10, the inventory amount to decrease on the display of the client device in a non-linear pace based on an easing function specifying a rate of change of the inventory over time.

18. The server computer of claim 10, wherein a random factor is added to the easing function to cause the inventory amount to decrease in a random pattern.

19. A non-transitory computer readable medium comprising instructions stored thereon that are executable by one or more processors to cause a computing device to perform operations comprising:
generating game-related data associated with player purchase of virtual goods in a game by a plurality of players;
selecting a subset of players from the plurality of players to purchase a limited amount of virtual goods;
determining player purchase behavior for the subset of players based on analyzing the game-related data associated with the player purchase of virtual goods by the subset of players
generating an inventory amount of virtual goods to offer to the subset of players based on the player purchase behavior for the subset of players;
causing the inventory amount of virtual goods to be displayed on a client device;
causing the inventory amount to decrease on e display of the client device in a non-linear pace.

20. The non-transitory computer readable medium of claim 19, the inventory amount to decrease on the display of the client device in a non-linear pace based on an easing function specifying a rate of change of the inventory over time wherein a random factor is added to the easing function to cause the inventory amount to decrease in a random pattern.
